(19) United States
(12) Patent Application Publication
(10) Pub. No.: US 2009/0089140 A1
(43) Pub. Date: Apr. 2, 2009

(54) SUPPORT MANAGEMENT METHOD, SUPPORT MANAGEMENT SYSTEM AND INFORMATION PROCESSING DEVICE

(75) Inventor: Takashi MIYAMOTO, Takamatsu (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/237,937

(22) Filed: Sep. 25, 2008

(30) Foreign Application Priority Data
Sep. 28, 2007 (JP) 2007-256108

(51) Int. Cl. G06Q 10/00

(52) U.S. Cl. 705/9

(57) ABSTRACT

A trouble-shooting measure against a fault in an external device installed at a remote place is supported by receiving fault information on the fault that has occurred in the external device, acquiring an installation place of the external device in which the fault has occurred, a repair procedure acquisition unit for acquiring a repair procedure representing a list of candidates of qualified maintenance persons and an outline of the fault that can be dealt with by the maintenance persons included in the list, acquiring a job situation of the maintenance person, and transmitting a trouble-shooting instruction against the fault to a communication terminal unit of a qualified maintenance person in accordance with the acquired repair procedure. Further, trouble-shooting instruction is transmitted in priority to an optimum maintenance person selected based on a relation between the acquired repair procedure and the job situation.

### CROSS-REFERENCE TO RELATED APPLICATIONS

This application is based upon and claims the benefit of priority from the prior Japanese Patent Application No.2007-256108 filed on Sep. 28, 2007, the entire contents of which are incorporated herein by reference.

### BACKGROUND

1. Field

The present invention relates to a trouble-shooting measure support management method capable of transmitting, in case of a fault in an external device, a trouble-shooting instruction and a priority notification to a communication terminal unit of an optimum maintenance person determined from the relation between the contents of the fault and the job situation of the maintenance person, a support management system for realizing the method and an information processing device included in the system.

2. Description of the Related Art

In recent years, the information processing systems such as the automatic cash transaction system, the automatic ticket selling system and other server/client systems have come to constitute the lifelines indispensable for various industries and the daily life. In view of this, various countermeasures are desirably conceived and taken quickly against a fault which may occur in the information processing systems.

A method has been employed, for example, to notify a fault, if detected in an information processing system, to a manager, who selects an optimum maintenance person taking the specifics of the fault and the skill and the level of the task of the maintenance person into consideration, and gives an instruction to the maintenance person thus selected. This method, however, poses the problem of personnel resources due to the fact that the manager is required to work around the clock to keep up with the ever-changing situation, and have the human skill to accurately select an optimum maintenance person without any decision error or delay and to issue an instruction quickly to the selected maintenance person.

In view of this, a conventional support management method using an information processing device such as a server in place of the manager has been proposed in which the particular information processing device notifies the communication terminal unit of the maintenance person in accordance with the notification procedure corresponding to the contents of the fault (described, for example, in Japanese Patent Application Laid-Open No. 2002-33731). The method described in Japanese Patent Application Laid-Open No. 2002-33731 has made it possible to accurately select a maintenance person and give an instruction quickly to the maintenance person without resorting to the skill of the manager. In the method described in Japanese Patent Application Laid-Open No. 2002-33731, however, the maintenance person is simply notified in accordance with the preset notification procedure without taking into consideration the current job situation of the maintenance person such as whether the maintenance person to be notified is off duty or in vacation and cannot be contacted, whether the maintenance person to be contacted is not a full-time worker and not well up to the local geography or whether the maintenance person contacted is not in a position to take a trouble-shooting measure immediately, thereby posing the problem that the maintenance person cannot be positively contacted.

### SUMMARY

According to an aspect of an embodiment, there is provided a support management method, wherein fault information on a fault occurring in an external device installed at a remote place is received by a management device supporting the trouble-shooting measure, the procedure for notifying the maintenance person is acquired based on the fault information received and a trouble-shooting instruction against the fault is transmitted to a communication terminal unit of the maintenance person to be contacted in accordance with the acquired notification procedure, and wherein the management device acquires the job situation of plural maintenance persons, selects an optimum maintenance person based on the relation between the acquired notification procedure and the job situation and gives a notification in priority to the communication terminal unit of the selected maintenance person according to the notification procedure.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram showing a general configuration of a support management system according to the invention;

FIG. 2 is a block diagram showing a configuration of a management device;

FIG. 3 is a diagram for explaining an example of storage in a fault information table;

FIG. 4 is a diagram for explaining an example of storage in a trouble-shooting measure list table;

FIG. 5 is a diagram for explaining an example of storage in a notification procedure list table;

FIG. 6 is a diagram for explaining an example of storage in a maintenance person information table;

FIG. 7 is a diagram for explaining an example of storage in a device information table;

FIG. 8 is a flowchart showing the steps of a trouble-shooting support management process executed by the management device;

FIG. 9 is a flowchart showing the steps of the trouble-shooting support management process executed by the management device;

FIG. 10 is a flowchart showing the steps of a trouble-shooting measure analysis process;

FIG. 11 is a flowchart showing the steps of a maintenance person information acquisition process;

FIG. 12 is a flowchart showing the steps of a contact address determining process;

FIG. 13 is a flowchart showing the steps of a remote trouble-shooting process; and

FIG. 14 is a flowchart showing the steps of a local trouble-shooting process.

### DETAILED DESCRIPTION OF THE PREFERRED EMBODIMENTS

Now, a support management system, a management device and a support management method according to the invention will be explained with reference to the drawings showing embodiments.

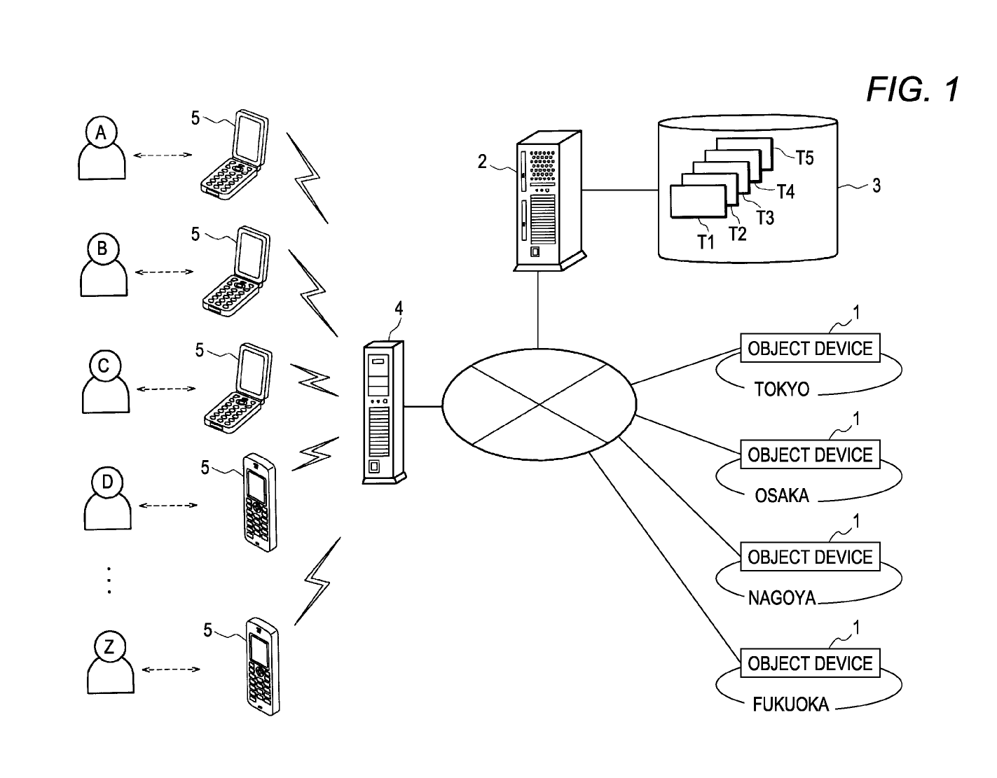

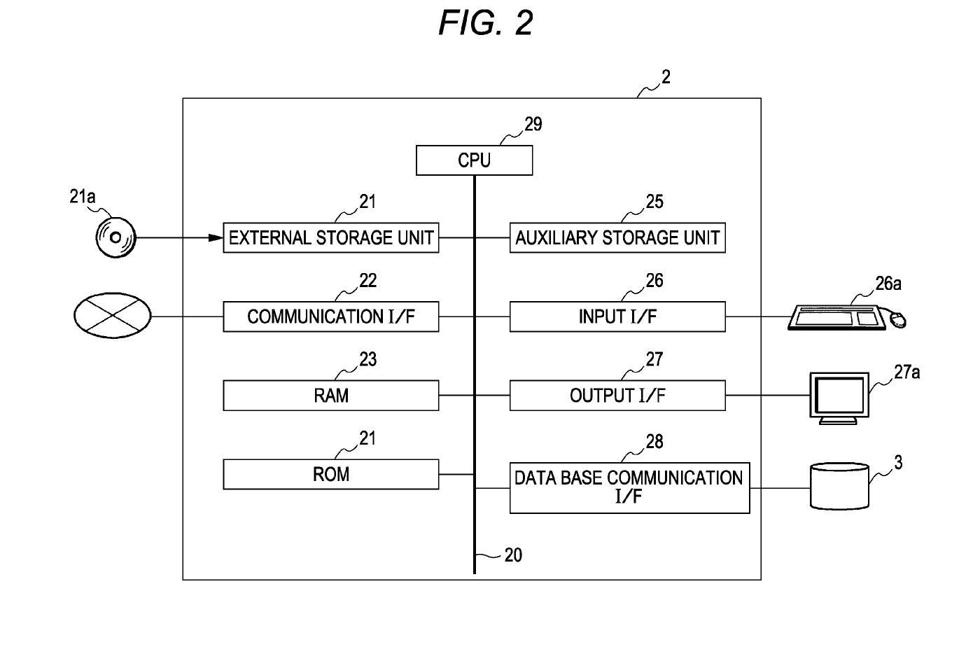

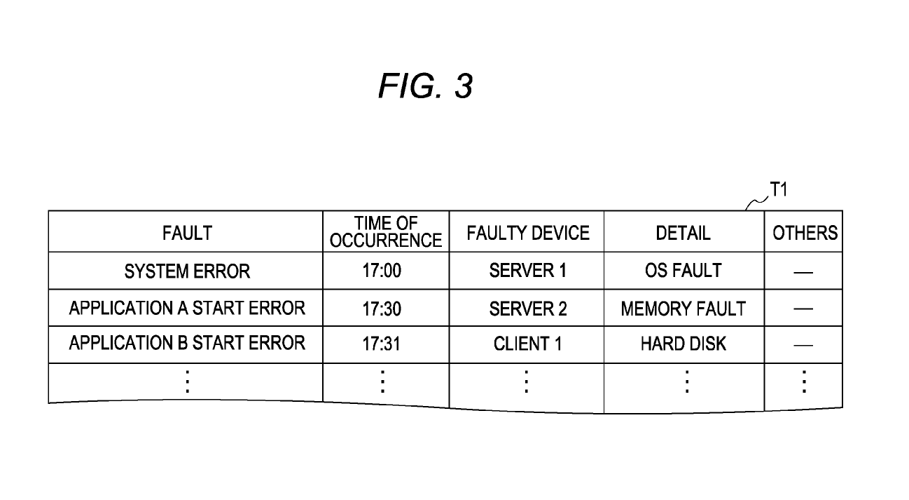

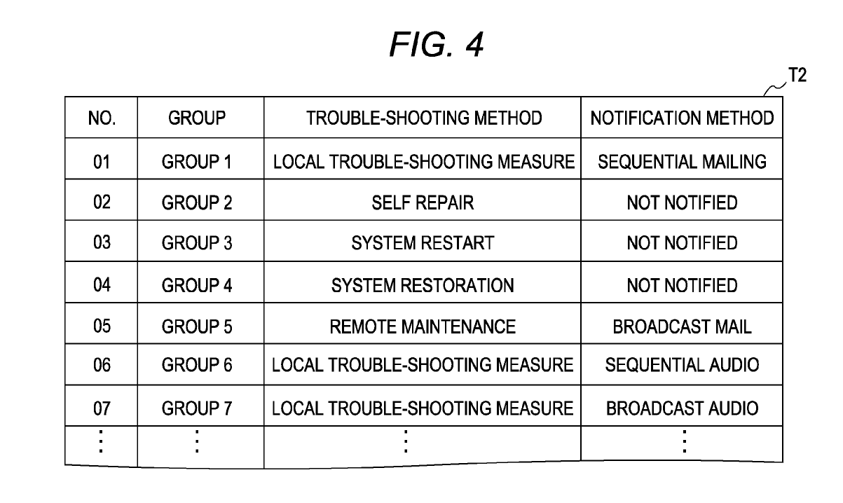

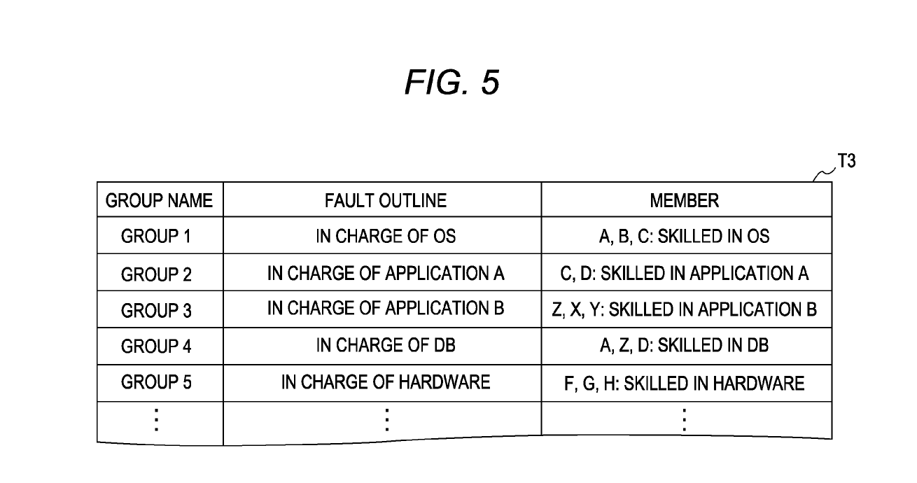

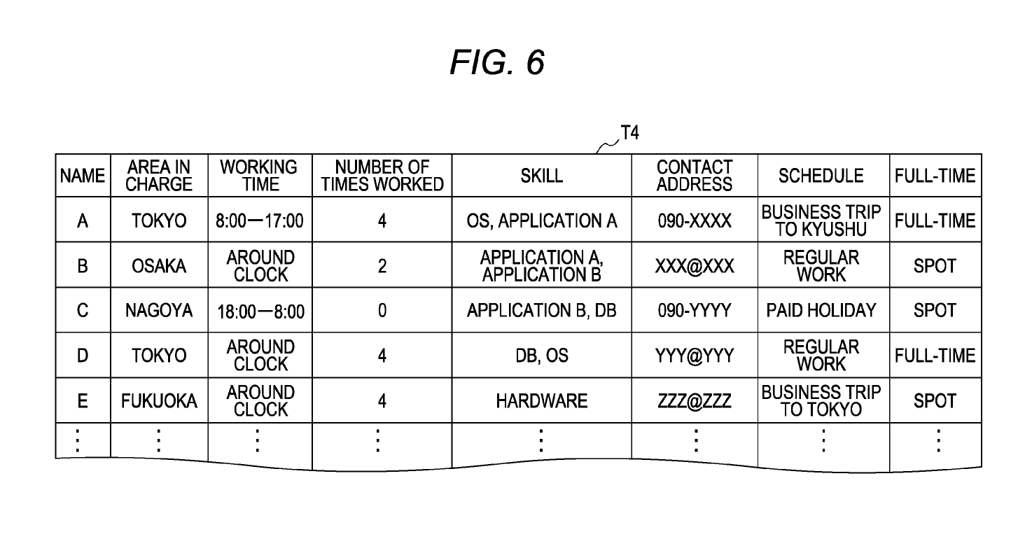

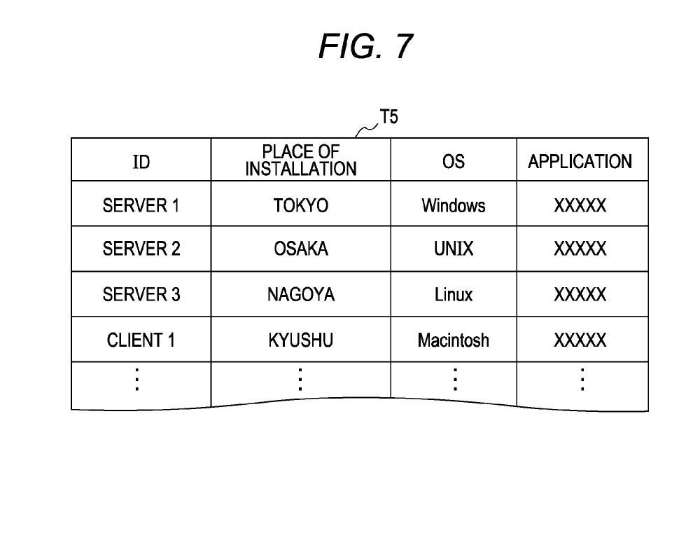

FIG. 1 is a diagram showing a general configuration of the support management system according to an embodiment, FIG. 2 a block diagram showing the configuration of the management device according to this embodiment, FIG. 3 a diagram for explaining an example of storage in a fault information table according to this embodiment, FIG. 4 a diagram for explaining an example of storage in a trouble-shooting measure list table according to this embodiment, FIG. 5 a diagram for explaining an example of storage in a notification procedure list table according to this embodiment, FIG. 6 a diagram for explaining an example of storage in a maintenance person information table according to this embodiment, and FIG. 7 a diagram for explaining an example of storage in a device information table according to this embodiment.

As shown in FIG. 1, the support management system includes a management device 2 for supporting the trouble-shooting measure, a data base 3 connected to the management device 2 and communication terminal units 5 to be contacted for contacting maintenance persons A to Z. Also, the support management system can communicate with object devices 1 outside the system and a web server 4 through a communication network. Each object device 1 is any external device which may be required to be repaired and has communication functions, such as (without limitation) a server PC, a client PC, a facsimile communication unit, an automatic cash transaction machine and an automatic ticket dispenser, etc. Multiple object devices 1 are installed at arbitrary places, for example, Tokyo, Osaka, Nagoya and Fukuoka.

Each object device 1 includes one or more of a fault detector (not shown) for detecting at least a fault occurring in itself, a transmission controller (not shown) for transmitting the fault information indicating the detected fault, a remote operation controller (not shown) adapted for remote operation according to a command and a self-restoration controller for executing such process(s) as the system restart, the system restoration or the self repair according to a command.

In FIG. 2, the management device 2 is for managing the support management system as a whole, and executes the various processes including at least the analysis of the trouble-shooting measure to be taken against a fault, the acquisition of the notification procedure, the acquisition of the maintenance person information, the construction of the notification procedure, the determination of the contact address, the transmission of the trouble-shooting instruction, the confirmation of the response to the notification, the confirmation of the completion of the trouble-shooting measure, the decision as to a full-time worker or not, the provisional issue of the entry/exit permission, the provision of the map information to the fault site, the confirmation of the authentication success and the cancellation of the entry/exit permission.

Although this embodiment deals with an example in which the processes are executed with a single management device 2, plural management devices 2 may share the job of executing the processes.

The management device 2 includes an external storage unit 21, a communication interface 22, a RAM 23, a ROM 24, an auxiliary storage unit 25, an input interface 26, an output interface 27, a data base communication interface 28 and a CPU 29. These hardware units are interconnected through a bus 20. The external storage unit 21 is for reading a program and various data stored in a recording medium 21a. Upon insertion of the recording medium 21a into an insertion hole (not shown), the external storage unit 21 reads the program and the various data stored in the recording medium 21a inserted, and outputs the program, etc. thus read to the RAM 23. The recording medium 21a has stored therein the program and the various data used by the CPU 29 to execute the various processes concerning the trouble-shooting support management. The recording medium 21a is an optical disk such as a DVD (digital versatile disk) or a CD (compact disk), a magnetic disk such as a flexible disk or a hard disk, a semiconductor disk such as an IC card, a semiconductor memory such as a mask ROM, an EPROM, an EEPROM or a flash ROM, or a magnetic tape.

The communication interface 22 is a terminal unit of the communication network and provides a window for communication with external devices such as the object devices 1, the web server 4 and the communication terminal units 5 through the communication network. The communication network is, for example, the internet, the intranet, the extranet, the LAN, the ISDN circuit network, the VAN, the CATV communication network, the virtual private network, the telephone line network, the mobile communication network or the satellite communication network. The communication interface 22 receives the various data accepted from external sources and outputs the various data thus received to the RAM 23. Also, the communication interface 22 sends out various data or control commands to external devices.

The transmission media used in the communication interface 22 include not only wired ones such as the IEEE1334, the USB, the power line carrier, the CATV channel, the telephone line and the ADSL channel but also the wireless ones such as the infrared ray, the BLUETOOTH, the 802.11 radio, the HDR, the portable phone channel, the satellite channel and the terrestrial wave digital network.

The RAM 23 is a main storage unit adapted to store plural information and read them regardless of the order or position in which they are stored. The RAM 23 is classified into SRAM and DRAM. The RAM 23 stores, for example, the program read from the ROM 24, the various data generated by execution of the program and the various signals received from external sources. The RAM 23 reads the stored data as required in accordance with the read instruction from the CPU 29. The ROM 24 is a main storage unit capable of storing plural information and reading them in any order or from any storage position. The information stored in the ROM 24 are not erased even in the case where the power thereof is switched off or to a lower level. The ROM 24 is configured of, for example, a semiconductor element and classified into a mask ROM, a PROM and a flash memory. The ROM 24 stores, for example, the programs or the various data permitting the management device 2 to execute the various processes for the trouble-shooting support management. The ROM 24 reads, as required, the stored data in accordance with a read instruction from the CPU 29.

The auxiliary storage unit 25 is, for example, a hard disk of magnetic memory type. The auxiliary storage unit 25 stores the programs and the various data read from the recording medium 21a.

The input interface 26 is connected to an input unit 26a. The input unit 26a is, for example, a keyboard or a mouse and outputs various instruction signals in accordance with the user input. The input unit 26a is used to input an instruction on the trouble-shooting support management. The input interface 26 receives the various instruction signals output from the input unit 26a and outputs the various instruction signals thus received to the CPU 29.

The output interface 27 is connected to a display unit 27a. The display unit 27a is used to output the video information on the trouble-shooting support management. The output interface 27 outputs the various information to the display unit 27a.

The data base communication interface 28 is connected to the data base 3 and provides a window for communication with the data base 3.

The CPU 29 controls each hardware of the management device 2 on the one hand and executes the various processes on the trouble-shooting support management on the other hand. The procedure for the various processes on the trouble-shooting support management executed by the management device 2 will be explained later.

The data base 3 is a collection of the information arranged and managed systematically, and implemented by the storage unit such as the hard disk of magnetic storage type. The data base 3 has stored therein plural tables which are read as required in accordance with an instruction from the CPU 29 of the management device 2.

An explanation is given about an example of storage in a fault information table T1, a trouble-shooting measure list table T2, a notification procedure list table T3, a maintenance person information table T4 and a device information table T5 stored in the data base 3. In FIG. 3, the fault information table T1 has stored therein the fault information on the faults that have occurred in each object device 1. The fault information stored in the fault information table T1 is held in correspondence with the contents of the fault, the time of fault occurrence, the object device in which the fault has occurred, the detail of the fault and other items. The object device 1 that has developed a fault transmits the fault detected by itself as fault information to the management device 2. The management device 2 receives the fault information transmitted thereto from the particular object device 1 and stores the received fault information in the fault information table T1 in chronological order of occurrence.

In FIG. 4, the trouble-shooting measure list table T2 has stored therein the information on the trouble-shooting measure against the fault, as classified according to the maintenance person group. The trouble-shooting measure information is held in correspondence with the maintenance person group to take charge of repairing the fault, the trouble-shooting method and the method of notification to each trouble-shooting maintenance person group.

The trouble-shooting methods include, in a non-limiting example, one or more of “the local measure” taken by the maintenance person at the site of fault, “the remote maintenance” in which the trouble-shooting measure is taken by the maintenance person from a remote place, “the system restart” in which the operation system (hereinafter referred to as “the OS”) is restarted, “the system restoration” for restoring the OS to the state before the fault and “the self repair” for repairing the data destroyed.

Also, the notification methods include, in a non-limiting example, one or more of “the sequential mail” for transmitting the mail sequentially, “the broadcast mail” for transmitting the mail at the same time to a plurality of maintenance persons and/or maintenance person groups, “the sequential audio” for sequentially transmitting the audio information, “the broadcast audio” for transmitting the audio information simultaneously to a plurality of maintenance persons and/or maintenance person groups and “the non-notification” in which no communication is conducted.

In FIG. 5, the notification procedure list table T3 has stored therein the repair procedure for notifying a maintenance person classified according to the group to which the maintenance person taking the trouble-shooting measure against the fault belongs. The repair procedure (herein also referred to as notification procedure) is held in correspondence with the name of the group to take a trouble-shooting measure, the outline of the fault that can be dealt with by each maintenance person group (i.e., fault handling capability or repair procedure), the names of or the skill owned by the members of each group. In the case where the fault outline (i.e., repair procedure) that can be dealt with is related to the fault that has occurred in the object device 1, the notification repair procedure for the maintenance person group in charge of the particular fault outline constitutes a candidate for the notification repair procedure. In the absence of the maintenance person group in charge of the outline of the fault that has occurred in the object device 1, however, the maintenance person group in charge of the fault outline analogous or approximate to the fault of the object device 1, for example, is selected as a candidate for the notification procedure. Also, according to an aspect of an embodiment, the names of the constituent members are stored in the order of notification of the trouble-shooting instruction, and this order can be used as the order of notification in the normal state.

In FIG. 6, the maintenance person information table T4 has stored therein the maintenance person information on the job situation classified according to each maintenance person. The maintenance person information is held, in a non-limiting example, in correspondence with one or more of the names of the maintenance persons, the area taken charge of by the maintenance persons, the time worked by the maintenance persons, the number of times worked by the maintenance persons, the skill owned by the maintenance persons, the contact address of the maintenance persons, the schedule of the maintenance persons and the data indicating whether the maintenance persons are full-time workers or not.

For example, in the case where the area taken charge of by a maintenance person is located in the neighborhood of the place of installation of the object device 1 that has developed a fault, for example, the maintenance person in charge of the particular area is selected as an optimum maintenance person. In the case where a fault occurs during the on-duty hours of a maintenance person, the notification to the particular maintenance person is judged possible. Also, in the case where different maintenance persons are at the same qualification level of the notification procedure information in table T3, the maintenance person who has worked a greater number of times is selected as an optimum maintenance person. Further, in the case where the skill owned by a maintenance person is related to the contents of the fault, the particular maintenance person owning the particular skill is selected as an optimum maintenance person. Furthermore, in the case where different maintenance persons are at the same qualification level of the notification procedure, the maintenance person having a greater skill is selected as an optimum maintenance person.

Also, the contact address of a maintenance person is that of the communication terminal unit 5 held privately by the particular maintenance person, which is, for example, the telephone number or the mail address of a mobile phone. The management device 2 transmits the various information to the communication terminal unit 5 indicated by the contact address.

Also, the schedule of the maintenance person is acquired by polling the existing schedule management system or each communication terminal unit 5 or by grasping the position of the communication terminal unit 5 by GPS. In the case where the schedule is a vacation such as “the paid holiday”, for example, the notification to the maintenance person on the particular schedule can be judged as impossible. Also, a full-time maintenance person is selected as an optimum maintenance person as compared with a spot (part-time) maintenance person. In the case where a spot maintenance person is selected as an optimum maintenance person, however, the entry/exit permit information is provisionally issued or the map information for the fault site is sent.

In FIG. 7, the device information table T5 has stored therein the device information classified according to each of the object devices 1. The device information is held, in a non-limiting example, in correspondence with one or more of the ID for identifying each object device 1, the place of installation of each object device 1, the OS for controlling each object device 1 and the name of the application installed in each object device 1. The maintenance person working (as a maintenance person in charge or on business trip) in the neighborhood of the place of installation is selected as an optimum maintenance person. Also, the maintenance person holding the skill related to the OS or the application installed is selected as an optimum maintenance person. The notification procedure for the maintenance person group in charge of the OS or the application installed constitutes a candidate for the notification procedure (see FIG. 5).

The web server 4 accumulates the information including the HTML document and the images, and in accordance with the request of the client software such as the web browser, functions to transmit these pieces of information through the communication network. The web server 4 functions to transmit not only the pull-type information such as the web site or the web mail but also the push-type information such as the electronic mail to each communication terminal unit 5.

Each communication terminal unit 5 is a communicable terminal unit privately owned or operated by each of the maintenance persons A to Z, such as a mobile phone, a PDA (personal digital assistant) with the communication function or a notebook-sized personal computer with the communication function. Also, each communication terminal unit 5 is set in correspondence with a maintenance person, so that the information to be notified to a predetermined maintenance person is transmitted to the corresponding communication terminal unit 5.

Each communication terminal unit 5 includes, in a non-limiting example, one or more of a communication controller for receiving the trouble-shooting instruction sent from the management device 2, a display unit for displaying the trouble-shooting instruction received, an input unit for receiving the input of a response signal, a remote operation unit for controlling a remote console, a command input unit supplied with a command on the remote operation, a command output unit for outputting the command, an input unit for inputting a completion signal indicating the completion of the trouble-shooting measure, a display unit for displaying the web browser, an input unit for inputting the job situation of the maintenance persons and a receiving unit for receiving the inquiry about the job situation of the maintenance persons.

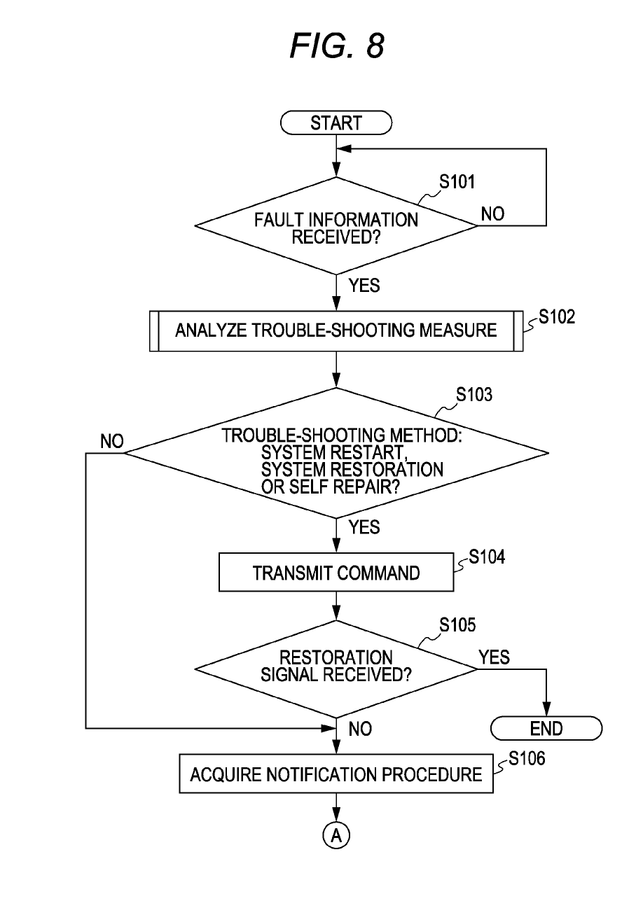

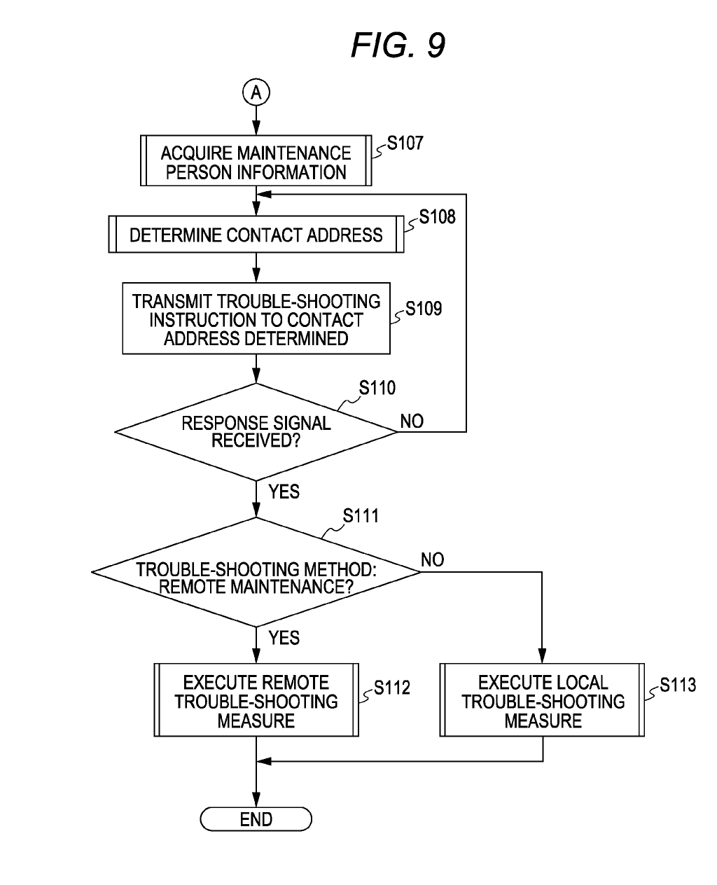

Next, the procedure for the trouble-shooting measure support management process executed by the management device 2 will be explained. FIGS. 8 and 9 are flowcharts showing the procedure for the trouble-shooting measure support management process executed by the management device 2. Each object device 1, upon occurrence of a fault, detects the fault and transmits the fault information on the detected fault. The CPU 29 of the management device 2 judges whether the fault information transmitted by each object device 1 has been received through the communication network or not (S101), and upon judgment that the fault information is not received (NO in step S101), determines that the object device 1 has not developed a fault, and repeats step S101 until the fault information is received. The CPU 29, on the other hand, executes the measure analysis process (S102) upon judgment that the fault information has been received (YES in step S101). The procedure for the trouble-shooting measure analysis process will be described later.

Also, the CPU 29 sequentially stores the received fault information in the fault information table T1. The CPU 29 judges whether the trouble-shooting method extracted in the trouble-shooting measure analysis process described later is associated with a non-notification or self troubleshooting type troubleshooting, for example, the system restart, the system restoration or the self repair (S103). In the case where the CPU 29 judges that the trouble-shooting method is not associated with the system restart, the system restoration or the self repair (NO in S103), the control proceeds to step S106 to acquire the notification procedure. In the case where the CPU 29 judges that the trouble-shooting method is associated with the system restart, the system restoration or the self repair (YES in S103), on the other hand, the command for activating these operation is transmitted to the object device 1 (S104).

Then, the object device 1 restarts the system, restores the system or repairs the fault by itself, as the case may be, in accordance with the received command, and upon restoration of the normal state, transmits the restoration signal. Incidentally, the process of carrying out the system restart, the system restoration or the self repair in accordance with the command uses the conventional technique, and therefore, the procedure thereof is not explained.

The CPU 29 judges whether the restoration signal transmitted from the object device 1 is received or not (S105), and upon judgment that the restoration signal is received (YES in step S105), judges that the fault of each object device 1 is repaired and finishes the trouble-shooting measure support management process. The CPU 29, upon judgment that the restoration signal is not received (NO in S105), on the other hand, acquires the notification procedure (S106). Specifically, the CPU 29 extracts, from the notification procedure list table T3, the members engaged in the job outline related to the contents of the fault extracted in the trouble-shooting measure analysis process. Then, the order in which the extracted members are arranged is acquired as the notification procedure.

The CPU 29 further executes the maintenance person information acquisition process (S107). The procedure for the maintenance person information acquisition process will be explained later. The CPU 29 further executes the contact address determining process based on the notification procedure and the maintenance person information acquired (S108). Incidentally, the procedure for the contact address determining process will be explained later. The CPU 29 transmits a trouble-shooting instruction to the contact address determined by the contact address determining process (S109). Specifically, the CPU 29 extracts, from the maintenance person information table T4, the contact address of the required maintenance person determined in the contact address determining process. Then, the trouble-shooting instruction is transmitted to the communication terminal unit 5 indicated by the extracted contact address.

The communication terminal unit 5 indicated by the extracted contact address receives, through the web server 4, the trouble-shooting instruction transmitted from the management device 2. The communication terminal unit 5 displays the received trouble-shooting instruction on the display unit (not shown). The communication terminal unit 5 receives, through the input unit (not shown), the input by the maintenance person as a response signal to the trouble-shooting instruction. The communication terminal unit 5 transmits the response signal. Incidentally, the communication terminal unit 5 not only receives the trouble-shooting instruction and displays it on the screen with the web browser, but also may receive the trouble-shooting instruction by an electronic mail or output with a voice indicating the trouble-shooting instruction.

The CPU 29 judges whether the response signal transmitted from the communication terminal unit 5 is received or not (S110), and upon judgment that the response signal is not received (NO in S110), judges that the notification to the determined contact address is impossible and returns the control to step S108 to execute the contact address determining process again based on the notification procedure for other than the particular contact address. As a result, the trouble-shooting instruction can be positively notified to any one of the maintenance persons.

The CPU 29, upon judgment that the response signal is received (YES in S110), on the other hand, judges whether the trouble-shooting method extracted in the trouble-shooting measure analysis process of step S102 corresponds to the remote maintenance or not (S111). Upon judgment that the trouble-shooting method corresponds to the remote maintenance (YES in S111), the CPU 29 executes the remote trouble-shooting process (S112) and thereby completes the trouble-shooting support management process. Incidentally, the procedure for the remote trouble-shooting process will be described later. Upon judgment that the trouble-shooting method does not correspond to the remote maintenance (NO in S111), on the other hand, the CPU 29 executes the local trouble-shooting process (S113) and completes the trouble-shooting support management process. Incidentally, the procedure for the local trouble-shooting process will be explained later.

As described above, according to the invention, the trouble-shooting measure against a fault that has occurred in an external device installed at a remote place can be accurately and quickly supported without resorting to the human skill of the manager on the one hand and taking the job situation of the maintenance person into consideration on the other hand.

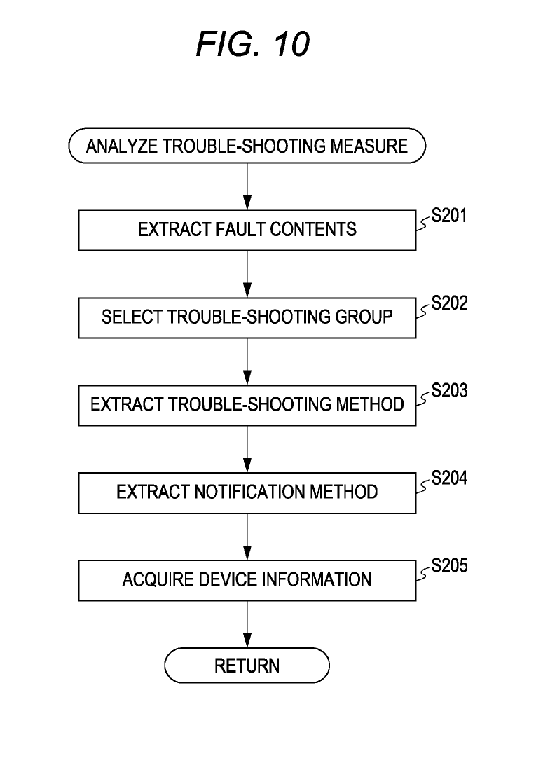

Next, the procedure for the trouble-shooting measure analysis process executed in step S102 by the management device 2 will be explained. FIG. 10 is a flowchart showing the procedure for the trouble-shooting measure analysis process. The CPU 29 of the management device 2 extracts the contents of the fault included in the fault information stored in the fault information table T1 (S201). Also, the CPU 29 extracts the outline of the extracted contents of the fault from the notification procedure list table T3, and selects the trouble-shooting maintenance person group corresponding to the extracted fault outline from the notification procedure list table T3 (S202). Further, the CPU 29 extracts the trouble-shooting method corresponding to the selected maintenance person group from the trouble-shooting measure list table T2 (S203). Also, the CPU 29 extracts the notification method corresponding to the extracted trouble-shooting method from the trouble-shooting measure list table T2 (S204). Furthermore, the CPU 29 extracts the object of the fault included in the fault information stored in the fault information table T1 and acquires the device information corresponding to the extracted object from the device information table T5 (S205). The CPU 29 stands by until the next process is restarted.

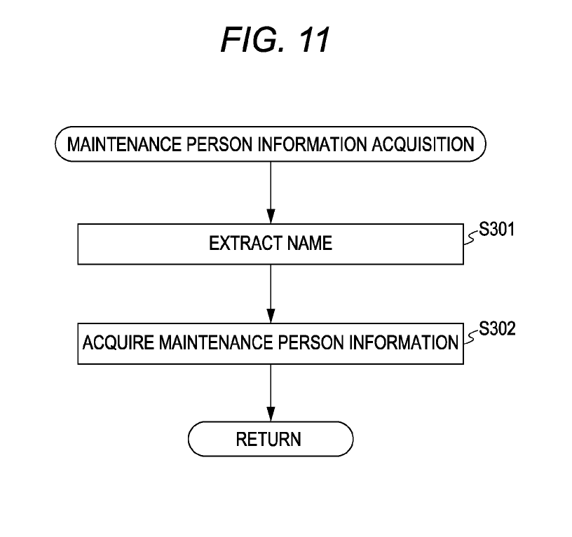

Next, the procedure for the maintenance person information acquisition process executed in step S107 by the management device 2 will be explained. FIG. 11 is a flowchart showing the procedure for the maintenance person information acquisition process. The CPU 29 of the management device 2 extracts, from the notification procedure list table T3, the name of each maintenance person included in the members making up the group selected in step S202 (S301). Also, the CPU 29 acquires the maintenance person information corresponding to the extracted name of each maintenance person from the maintenance person information table T4 (S302). The CPU 29 stands by until the next process is restarted.

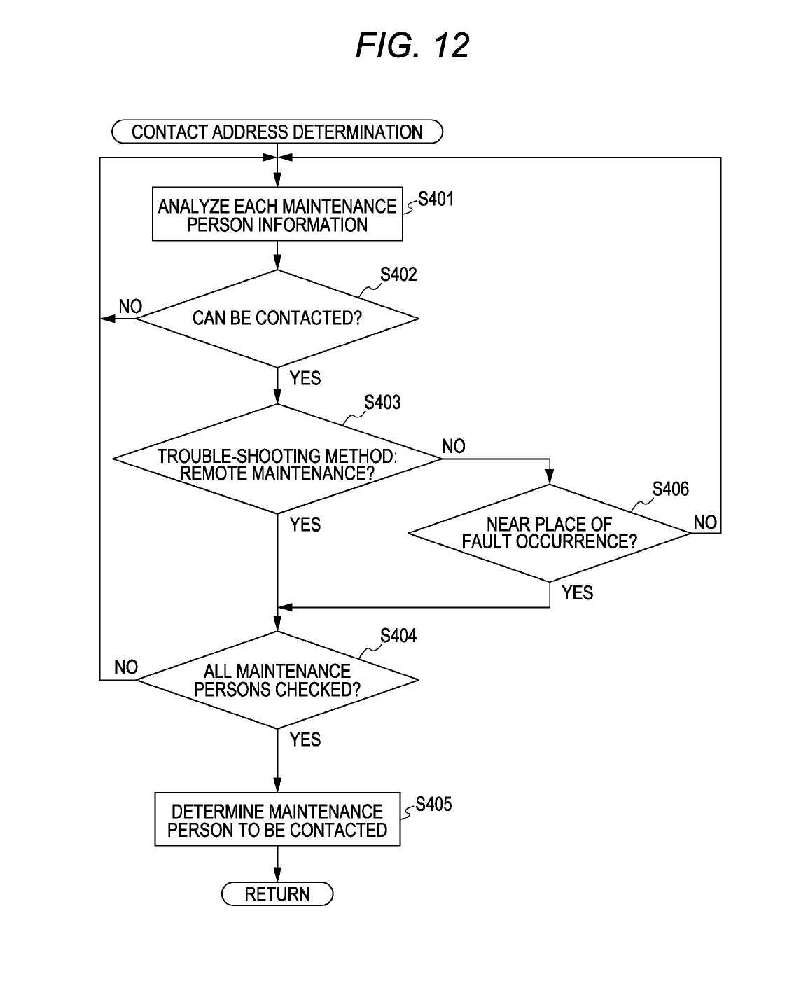

Next, the procedure for the contact address determining process executed in step S108 by the management device 2 will be explained. FIG. 12 is a flowchart showing the procedure for the contact address determining process. The CPU 29 of the management device 2 analyzes the information on each maintenance person included in the maintenance person information acquired in step S302 (S401). The CPU 29 judges whether the maintenance person can be contacted or not, based on the on-duty hours or the schedule (S402), and upon judgment that the maintenance person cannot be contacted (NO in S402), returns the control to step S401 to analyze the information on a maintenance person constituting the next candidate. Then, the process is repeated.

The maintenance person cannot be contacted in the case where the maintenance person is off duty or in the vacation such as the paid holiday or in the case where the portable terminal unit 5 fails to respond. Incidentally, the portable terminal unit 5 fails to respond, for example, in the case where the command such as the Ping command to confirm the communicability is not answered. The maintenance person cannot be contacted not only in these cases, but also in the case where the positional information cannot be acquired from the portable terminal unit 5. The CPU 29, upon judgment that the maintenance person can be contacted (YES in S402), on the other hand, judges whether the trouble-shooting method extracted in step S203 corresponds to the remote maintenance or not (S403).

The CPU 29, upon judgment that the trouble-shooting method corresponds to the remote maintenance (YES in S403), judges whether all the maintenance persons in the notification procedure list T3 have been checked or not (S404). The CPU 29, upon judgment that all the maintenance persons in the notification procedure list T3 are not checked (NO in S404), returns the control to step S401 and analyzes the information on a maintenance person as the next candidate. Then, the process is repeated. The CPU 29, upon judgment that all the maintenance persons in the notification procedure list T3 are checked (YES in S404), on the other hand, determines a particular maintenance person as a person to be contacted on the basis of a result of processing S406 described later (S405), and completing the contact address determination process, stands by until the restart of the next process.

The CPU 29, upon judgment in step S403 that the trouble-shooting method fails to correspond to the remote maintenance (NO in S403), judges whether the maintenance person is present in the neighborhood of the place of fault (the position where the faulty device 1 is installed) based on the area in his/her charge or his/her schedule (S406). The CPU 29, upon judgment that the maintenance person is absent in the neighborhood of the place of fault (NO in S406), returns the control to step S401, and analyzing the information on a maintenance person as the next candidate, repeats the process. The maintenance person is considered absent in the neighborhood of the place of fault, for example, in the case where the area in his/her charge or the place visited by him/her on business trip is located at a far distance from the place of fault or in another town.

The CPU 29, upon judgment that the maintenance person is present in the neighborhood of the place of fault (YES in S406), on the other hand, extracts the judged maintenance person in the list T3 (YES in S406), judges whether all the maintenance persons in the notification procedure list T3 are checked or not (S404). The CPU 29, upon judgment that all the maintenance persons in the notification procedure list T3 are not checked (NO in S404), returns the control to step S401, and analyzing the information on a maintenance person as the next candidate, repeats the process. The CPU 29, upon judgment that all the maintenance persons in the notification procedure list T3 are checked (YES in S404), on the other hand, determines a particular maintenance person as a person to be contacted on the basis of the information representing the maintenance person that is extracted by the S406 process (S405), and completing the contact address determination process, stands by until the restart of the next process.

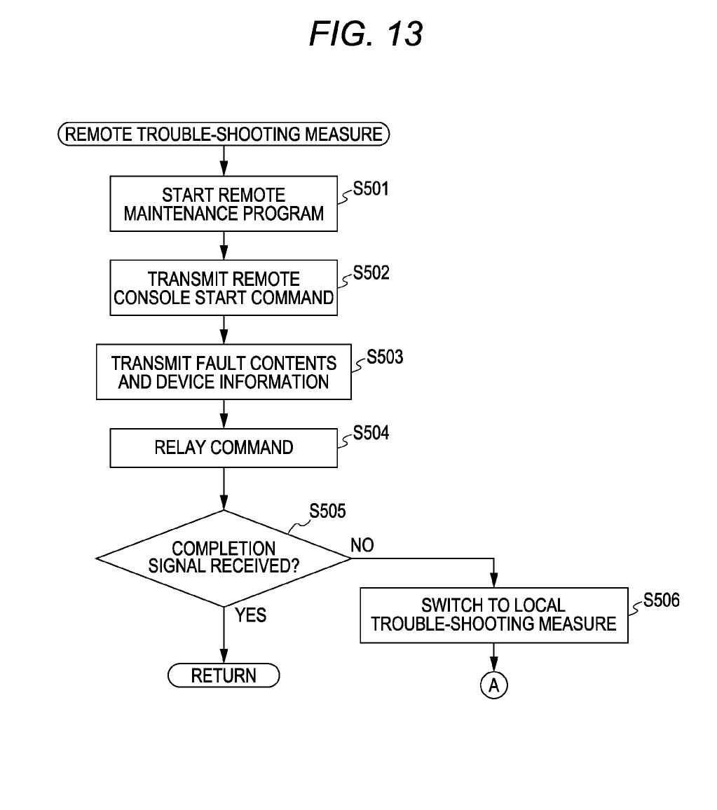

Next, the procedure for the remote trouble-shooting process executed by the management device 2 in step S112 will be explained. FIG. 13 is a flowchart showing the procedure for the remote trouble-shooting process. The CPU 29 of the management device 2 starts the remote maintenance program read from the auxiliary storage unit 25 (S501).

The CPU 29 generates the remote console start command in accordance with the remote maintenance program thus started, and transmits the generated remote console start command to the communication terminal unit 5 constituting the destination of the response signal received in step S110 (S502). Further, the CPU 29 transmits to the communication terminal unit 5 the contents of the fault extracted in step S201 and the device information acquired in step S205 (S503). As a result, the maintenance person, by studying the contents of the fault that has occurred and the information on the faulty device 1 that has developed the particular fault, can take a correct measure against the fault.

The CPU 29 relays the command on the remote maintenance between the communication terminal unit 5 and the faulty device 1 that has developed the fault (S504). Incidentally, the command relay is the conventional technique and not explained. Upon completion of the remote trouble-shooting measure, the communication terminal unit 5 receives the completion signal input by the maintenance person through the input unit (not shown). The communication terminal unit 5 transmits the completion signal. The CPU 29, upon judgment whether the completion signal transmitted from the communication terminal unit 5 has been received or not (S505) and that the completion signal has not been received (NO in S505), determines that the remote trouble-shooting method cannot be used and switches to the local trouble-shooting method (S506). After that, returning to step S107, the process is repeated. In this case, the CPU 29 regards the trouble-shooting method as not corresponding to the remote maintenance in the contact address determining process (see S403), and executes the process to judge whether some maintenance person is present in the neighborhood of the place of fault (see S406).

The CPU 29, upon judgment that the completion signal is received (YES in S505), on the other hand, stands by until the restart of the next process. The CPU 29 completes the trouble-shooting support management process upon completion of the remote trouble-shooting process.

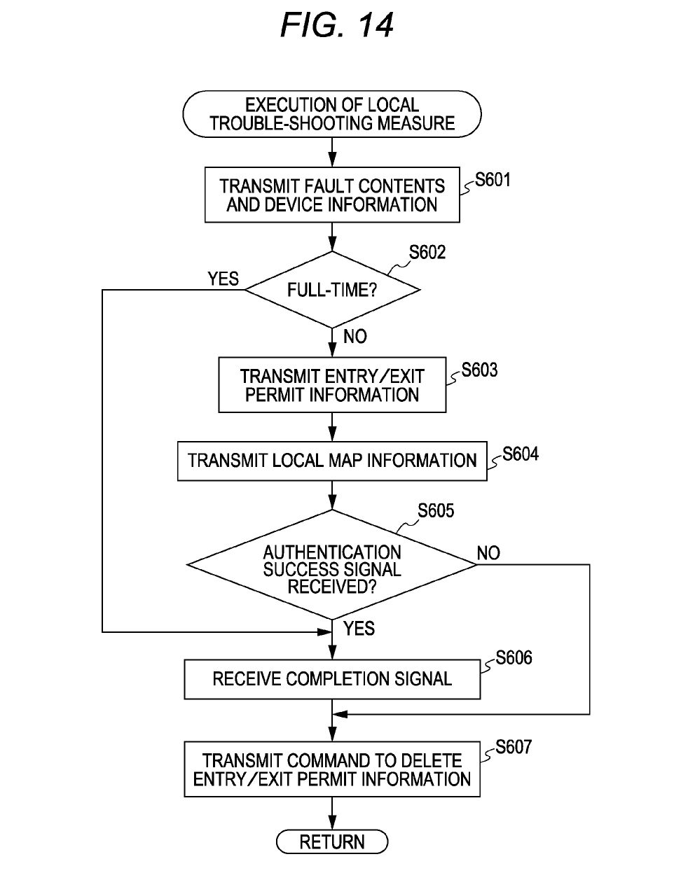

Next, the procedure for the local trouble-shooting process executed in step S113 by the management device 2 will be explained. FIG. 14 is a flowchart showing the procedure for the local trouble-shooting process. The contents of the fault extracted in step S201 and the device information acquired in step S205 are transmitted by the CPU 29 of the management device 2 to the communication terminal unit 5 constituting the destination of the response signal received in step S110 (S601).

The CPU 29, upon judgment whether the maintenance person is a full-time worker in charge of the trouble-shooting measure against the faulty device 1 (S602) and that the particular maintenance person is not a full-time worker in charge of the trouble-shooting measure against the faulty device 1 (NO in S602), transmits the entry/exit permit information to the particular communication terminal unit 5 (S603). As a result, the part-time maintenance person is not rejected to enter or exit from the place of installation visited by him/her for the first time. The entry/exit permit information is in the form of, for example, the data that can be stored in the communication terminal unit 5. The communication terminal unit 5, by transmitting the entry/exit permit information wirelessly using his/her own no-contact antenna, seeks the permission to enter or exit from the entry/exit permit determining unit arranged at the place of installation of the faulty device 1.

Further, the CPU 29 transmits to the communication terminal unit 5 the site map information indicating the route to the place of installation of the faulty device 1 that has developed the fault (S604). As a result, the part-time maintenance person can rush, without losing his/her way, to the place of installation to be visited by him/her for the first time.

Also, the site map information is the information on the place of installation contained in the device information table T5 and displayed in superposition on the screen. This information further includes the route from the present position of the maintenance person to the place of installation and the required time to cover the distance.

In the case where the authentication at the place of installation of the faulty device 1 using the entry/exit permit information is successful, the communication terminal unit 5 generates an authentication success signal. The communication terminal unit 5 transmits the authentication success signal thus generated.

Also, upon completion of the local trouble-shooting process by the maintenance person that has entered the place of installation, the communication terminal unit 5 receives the completion signal input by the maintenance person through the input unit (not shown). The communication terminal unit 5 transmits the completion signal.

The CPU 29, upon judgment whether the authentication success signal transmitted from the communication terminal unit 5 is received or not (S605) and that the authentication success signal is not received (NO in S605), determines that the entry/exit permit information is not required and transmits the command to delete the entry/exit permit information to the communication terminal unit 5 (S607). In this way, the illegal use of the entry/exit permit information issued provisionally to the part-time maintenance person is avoided.

The CPU 29, upon judgment that the authentication success signal is received (YES in S605), on the other hand, receives the completion signal transmitted from the communication terminal unit 5 (S606) and transmits the command to delete the entry/exit permit information to the communication terminal unit 5 (S607). In this way, the illegal use of the entry/exit permit information which may be issued to the part-time maintenance person is avoided.

The CPU 29 stands by until the restart of the next process. The CPU 29 completes the trouble-shooting support management process at the end of the local trouble-shooting process.

The CPU 29, upon judgment that the maintenance person is a full-time worker in charge of the trouble-shooting measure against the faulty device 1 in step S602 (YES in S602), on the other hand, receives the completion signal transmitted from the communication terminal unit 5 (S606) and transmits the command to delete the entry/exit permit information to the communication terminal unit 5 (S607). Thus, the illegal use of the entry/exit permit information for the part-time maintenance person which may be erroneously sent to the full-time maintenance person is avoided by deleting it.

The embodiments described above represent a case in which, in the case where different maintenance persons are at the same qualification level in the notification procedure, for example, the maintenance person who has taken charge of the repair work a greater number of times is selected as an optimum maintenance person.

The invention, however, is not limited to such a case. As an alternative, the maintenance person may be selected in such a manner as to average out the number of times taken charge of by all the maintenance persons, for example, to prevent the instructions from being concentrated on a specified maintenance person.

According to an aspect of the aforementioned embodiment, an accurate and quick instruction can be issued to a maintenance person capable of dealing with a fault of an external device installed at a remote place without resorting to the human skill of the manager.

Also, the instruction can be issued dynamically to the most suitable maintenance person taking his/her job situation into consideration.

Also, according to an aspect of an embodiment, there is provided a support management system including a management device for supporting the trouble-shooting measure by receiving the fault information on the fault that has developed in an external device installed at a remote place and plural communication terminal units communicable with the management device, wherein the management device includes a unit acquiring the procedure for notification to the maintenance person based on the received fault information and a transmission unit transmitting a trouble-shooting instruction against the fault to the communication terminal unit of the maintenance person to be contacted in accordance with the acquired notification procedure, wherein the management device further includes an acquisition unit acquiring the job situation of each of plural maintenance persons, and a select unit selecting the optimum maintenance person based on the relation between the acquired notification procedure and the job situation, and wherein the transmission unit gives priority in the notification procedure to the transmission to the communication terminal unit of the maintenance person selected by the select unit.

According to an aspect of an embodiment, the notification procedure is acquired based on the fault information, and the trouble-shooting instruction against the fault is transmitted to the maintenance person in accordance with the acquired notification procedure, so that an instruction is issued accurately and quickly to the maintenance person capable of taking a trouble-shooting measure against the fault of the external device installed at a remote place without resorting to the human skill of the manager.

Further, the job situation of each of the plural maintenance persons is acquired and by taking the relation between the acquired notification procedure and the job situation into consideration, the transmission to the communication terminal unit of the selected maintenance person is given priority, so that the instruction is given dynamically to the most suitable maintenance person taking the job situation of the particular maintenance person into consideration.

Also, according to an aspect of an embodiment, the management device further includes a judging unit for judging whether the external device that has developed a fault can deal with the fault by itself or not, and upon judgment that the external device can deal with the fault by itself, the transmission unit performs no transmission to the communication terminal unit of the maintenance person.

According to an aspect of an embodiment, upon judgment that the external device that has developed a fault can deal with the fault by itself, no instruction is given to the maintenance person, and therefore, the useless transmission of the trouble-shooting instruction to the maintenance person is eliminated.

According to an aspect of an embodiment, the acquisition unit of the support management system acquires the job situation including the data indicating whether the maintenance person is at least in a position to confirm the trouble-shooting instruction, and the select unit deletes any maintenance persons not in a position to confirm the trouble-shooting instruction from the maintenance person select process.

According to an aspect of an embodiment, any maintenance person off duty or in vacation is determined as a maintenance person who cannot be contacted and deleted from the maintenance person select process, and the notification to other maintenance persons is considered, thereby making it possible to notify the maintenance persons positively.

According to an aspect of an embodiment, there is provided an information processing device including a unit receiving the fault information on a fault developed in an external device installed at a remote place, a unit acquiring the procedure for notification to a maintenance person based on the received fault information, an instruction transmission unit transmitting a trouble-shooting instruction against the fault to the communication terminal unit of the maintenance person to be contacted in accordance with the acquired notification procedure, a state acquisition unit acquiring the job situation of plural maintenance persons, and a maintenance person select unit selecting the optimum maintenance person based on the relation between the acquired notification procedure and the job situation, wherein the instruction transmission unit gives priority, in the acquired notification procedure, to the transmission to the communication terminal unit of the maintenance person selected by the maintenance person select unit.

According to an aspect of an embodiment, the notification procedure is acquired based on the fault information, and in accordance with the notification procedure thus acquired, a trouble-shooting instruction against the fault is transmitted to the maintenance person. Thus, the instruction can be issued accurately and quickly to the maintenance person capable of dealing with the fault of the external device installed at a remote place without resorting to the human skill of the manager.

Further, the job situation of each of plural maintenance persons is acquired, and the instruction is sent giving priority to the communication terminal unit of the maintenance person selected taking the relation between the acquired notification procedure and the job situation into consideration. As a result, the instruction is issued dynamically to the most suitable maintenance person taking the job situation of the maintenance person into consideration.

Furthermore, according to an aspect of an embodiment, the instruction by remote control operation is given in such a manner that the full-time maintenance person can execute the trouble-shooting measure as far as possible. Thus, the trouble-shooting measure against the fault can be positively carried out.

In the local trouble-shooting operation, on the other hand, an instruction is given to the maintenance person working in the neighborhood of the place of installation of the faulty external device to rush to the place of installation and take a trouble-shooting measure quickly against the fault.

Further, even a part-time maintenance person can take an appropriate measure by quickly moving to the place of installation with reference to the map information on the place of installation sent to him/her.

Also, in the local trouble-shooting operation, the entry/exit permit information for the place of installation of the faulty external device is transmitted to the maintenance person. Even in the case where the maintenance person is a part-time worker and holds no written entry/exit permission, therefore, the data effective as the entry/exit permission is immediately issued so that the maintenance person can rush to the place of installation to quickly take an appropriate measure against the fault.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of transmission communication media includes a carrier-wave signal.

Further, according to an aspect of the embodiments of the invention, any combinations of the described features, functions, operations, and/or benefits can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A support management method used with a management device for supporting a trouble-shooting measure against a fault in an external device, the support management method comprising:
receiving fault information on the fault that has occurred in the external device;
a installation place acquisition unit for acquiring an installation place of the external device in which the fault has occurred, on the basis of the receiving fault information;
a repair procedure acquisition unit for acquiring a repair procedure representing a list of candidates of qualified maintenance persons and an outline of the fault that can be dealt with by the maintenance persons included in the list, on the basis of a relation between the outline of the fault and the fault represented by the receiving fault information;
acquiring a job situation of the one or more qualified maintenance persons included in the list; and
transmitting in priority a trouble-shooting instruction against the fault to a communication terminal unit of an optimum qualified maintenance person selected based on a relation between the acquired installation place and the job situation of a maintenance person.

2. A support management computer system for supporting a trouble-shooting measure against a fault that has occurred in an external device installed at a remote place, the support management system comprising:
a computer processor executing
a receiving unit for receiving fault information on the fault that has occurred in the external device;
a installation place acquisition unit for acquiring an installation place of the external device in which the fault has occurred, on the basis of the receiving fault information;
a repair procedure acquisition unit for acquiring a repair procedure representing a list of candidates of qualified maintenance persons and an outline of the fault that can be dealt with by the maintenance persons included in the list, on the basis of a relation between the outline of the fault and the fault represented by the receiving fault information;
a job situation acquisition unit for acquiring a job situation of the one or more qualified maintenance persons included in the list; and
a transmission unit for transmitting in priority a trouble-shooting instruction against the fault to a communication terminal unit of an optimum qualified maintenance person selected from the candidates of qualified maintenance persons based on a relation between the acquired installation place and the job situation of a maintenance person.

3. The support management computer system according to claim 2, wherein the computer processor further executes a self restoration judging unit for judging whether the fault indicated by the received fault information can be dealt with by the external device through a self restoration process,
wherein the transmission unit, upon judgment by the self restoration judging unit that the external device can troubleshoot through the self restoration process, does not perform the trouble-shooting instruction transmission.

4. The support management system according to claim 2,
wherein the job situation acquisition unit acquires the job situation including data indicating whether the maintenance person is in a position at least to confirm the trouble-shooting instruction, and
the transmission unit deletes the maintenance person not in a position to confirm the trouble-shooting instruction from the candidates of the qualified maintenance persons.

5. The support management system according to claim 2, wherein the computer processor further executes a trouble-shooting measure type specifying unit for selecting a remote trouble-shooting measure or a local trouble-shooting measure,
wherein upon designation of a remote trouble-shooting instruction by the trouble-shooting measure type specifying unit, the job situation acquisition unit acquires the job situation including data indicating whether the maintenance person is a full-time worker, and the transmission unit gives transmission priority to a communication terminal unit of the full-time maintenance person.

6. The support management system according to claim 5,
wherein upon designation of a local trouble-shooting instruction by the trouble-shooting measure type specifying unit, the acquisition unit acquires the job situation including data indicating whether the maintenance person is working in a neighborhood of a place of installation of the faulty external device, and
the transmission unit gives transmission priority to a communication terminal unit of a maintenance person working in the neighborhood of the place of installation of the faulty external device.

7. The support management system according to claim 6, wherein the transmission unit transmits, together with the trouble-shooting instruction, entry/exit permit information for permitting entry into/exit from the place of installation of the faulty external device and map information on the place of installation.

8. An information processing device comprising:
a computer readable recording medium; and
a computer processor executing
storing in the computer readable recording medium received fault information on a fault developed in an external device installed at a remote place;
acquiring an installation place of the external device in which the fault has occurred, on the basis of the receiving fault information;
acquiring a repair procedure representing a list of candidates of qualified maintenance persons and an outline of the fault that can be dealt with by the maintenance persons included in the list, on the basis of a relation between the outline of the fault and the fault represented by the receiving fault information;
acquiring a job situation of one or more maintenance person included in the list; and
selecting an optimum maintenance person from among the qualified maintenance persons based on a relation between the acquired installation place and the job situation of a maintenance person; and
transmitting a trouble-shooting instruction to a communication terminal unit of an optimum qualified maintenance person, according to the selecting.

9. The information processing device according to claim 8, wherein the computer processor further executes:
judging whether the external device that has developed a fault can deal with the fault, and
not transmitting an instruction to the communication terminal unit of the maintenance person when judged that the external device can deal with the fault.

10. The information processing device according to claim 8, wherein the acquiring acquires the job situation including data indicating at least whether the maintenance person is in a position to confirm the trouble-shooting instruction, and the selecting deletes the maintenance person not in a position to confirm the trouble-shooting instruction from the selection process.

11. The information processing device according to claim 8, wherein the computer processor further executes selecting a remote trouble-shooting measure or a local trouble-shooting measure,
wherein upon designation of a remote trouble-shooting measure, the acquiring acquires the job situation including data indicating whether the maintenance person is a full-time worker, and the selecting selects in priority the full-time maintenance person as the optimum qualified maintenance person.

12. The information processing device according to claim 11, wherein upon designation of a local trouble-shooting measure, the acquiring acquires the job situation including data indicating whether the maintenance person is working in a neighborhood of a place of installation of the faulty external device, and the selecting selects in priority the maintenance person working in the neighborhood of the place of installation of the faulty external device as the optimum qualified maintenance person.

13. The information processing device according to claim 12, wherein the transmitting transmits, together with the trouble-shooting instruction, entry/exit permit information for the place of installation of the faulty external device and map information on the place of installation.
